(19) United States
(12) Patent Application Publication
(10) Pub. No.: US 2012/0236834 A1
(43) Pub. Date: Sep. 20, 2012

(54) POWER OPTIMIZATION FOR SMART PHONE APPLICATIONS

(75) Inventors: Saiyiu D. Ho, San Diego, CA (US); Hao Xu, San Diego, CA (US); Yongbin Wei, San Diego, CA (US)

(73) Assignee: QUALCOMM Incorporated, San Diego, CA (US)

(21) Appl. No.: 13/424,316

(22) Filed: Mar. 19, 2012

Related U.S. Application Data
(60) Provisional application No. 61/453,912, filed on Mar. 17, 2011.

(51) Int. Cl. H04W 72/04; H04W 68/00

(52) U.S. Cl. 370/337

(57) ABSTRACT

A method, an apparatus, and a computer program product for wireless communication arc provided. The apparatus may be a UE. The UE may enter a gated mode including a first time period followed by a second time period, prevent application initiated data generated during the first time period from being transmitted over-the-air during the first time period, and permit over-the-air transmission during the second time period of the application initiated data generated during the first time period.

### CROSS-REFERENCE TO RELATED APPLICATION(S)

This application claims the benefit of U.S. Provisional Application Ser. No. 61/453,912, entitled “Power Optimization for Smart Phone Applications” and filed on Mar. 17, 2011, which is expressly incorporated by reference herein in its entirety.

### BACKGROUND

1. Field

The present disclosure relates generally to communication systems, and more particularly, for power optimization for smartphone applications.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

With the ever increasing popularity of smartphones, there are many new challenges for the optimization of wireless systems, including power consumption and signaling demands. Typically, instead of remaining awake for relatively brief periods during voice calls, smartphones are awake much more often. For example, Applications such as email or Facebook™ may send a “keep-alive” message every 20 to 30 minutes. These and other applications often use many small and bursty data transmissions that will require significantly larger amount of control signaling. Some system level evaluations have identified control channel limitations in addition to traffic channel limitations.

Discontinuous Reception (DRX) is one method used in mobile communication to conserve the battery of the mobile device. The mobile device and the network negotiate phases in which data transfer occurs. During other times, the device turns its receiver off and enters a low power state. This is usually a function designed into the protocol that allows this to happen using, for example, in slots with headers containing address details so that devices can listen to these headers in each slot to decide whether the transmission is relevant to them or not. In this case, the receiver only has to be active at the beginning of each slot to receive the header, conserving battery life. Other DRX techniques include polling, whereby the device is placed into standby for a specified period of time and then a beacon is periodically sent by a remote apparatus, such as an access point or base station, to indicate whether there is any data waiting for the device.

In LTE, DRX is controlled by the radio resource control (RRC). The RRC sets a cycle where a receiver of a user equipment (UE) (e.g., smartphone) is operational for a specified period of time when all the scheduling and paging information is transmitted and thereafter disabled. The evolved Node B (eNB) has knowledge during the period when the receiver of the UE is disabled and cannot receive any transmissions. For example, when in DRX, the UE radio may be activated to monitor the Physical Downlink Control CHannel (PDCCH) to identify downlink data and thereafter disabled. In LTE, DRX also applies to the RRC_Idle state with a longer cycle time than the active mode.

A UE may operate in an RRC_Idle state, where the radio is not active, but an identification (ID) is assigned to the UE and tracked by the network. Otherwise, the UE may operate in an RRC_Connected state for active radio operation with context in the eNB.

In the active state, there is dynamic transition between long and short DRX cycles. Long DRX has a longer “off” duration. Durations for long and short DRX are configured by the RRC. The transition is determined by the eNB (MAC commands) or by the UE based on an activity timer. For example, a lower duty cycle could be used during a pause in speaking during a voice over IP call; packets are arriving at a lower rate, so the UE can be off for a longer period of time. When speaking resumes, this results in lower latency. Packets are arriving more often, so the DRX interval is reduced during this period.

With traditional voice calls, users are either on the phone talking or inactive. However, most modern smartphones have completely different usage patterns. Some applications that run on smartphones, such as video streaming or video conferencing, can generate large amounts of traffic. Other applications, such as email applications, generate periodic updates even during night time. Still other applications send periodic keep-alive messages or status messages. Thus, actual talk time may only constitute a small fraction of the usage of a smartphone. It would be desireable for managing or controlling such applications for power and control signal reduction.

Therefore, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus enters a gated mode comprising a first time period followed by a second time period, prevents application initiated data generated during the first time period from being transmitted over-the-air during the first time period, and permits over-the-air transmission during the second time period of the application initiated data generated during the first time period.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a traffic distribution for a UE operating in a medium active state.

FIG. 8 is a diagram of an exemplary network for implementing an exemplary method.

FIG. 9 is a diagram illustrating an exemplary gating pattern that may be used by a UE for the gated mode of operation.

FIG. 10 is a flow chart of a method of wireless communication.

FIG. 11 is a flow chart of a method of wireless communication.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

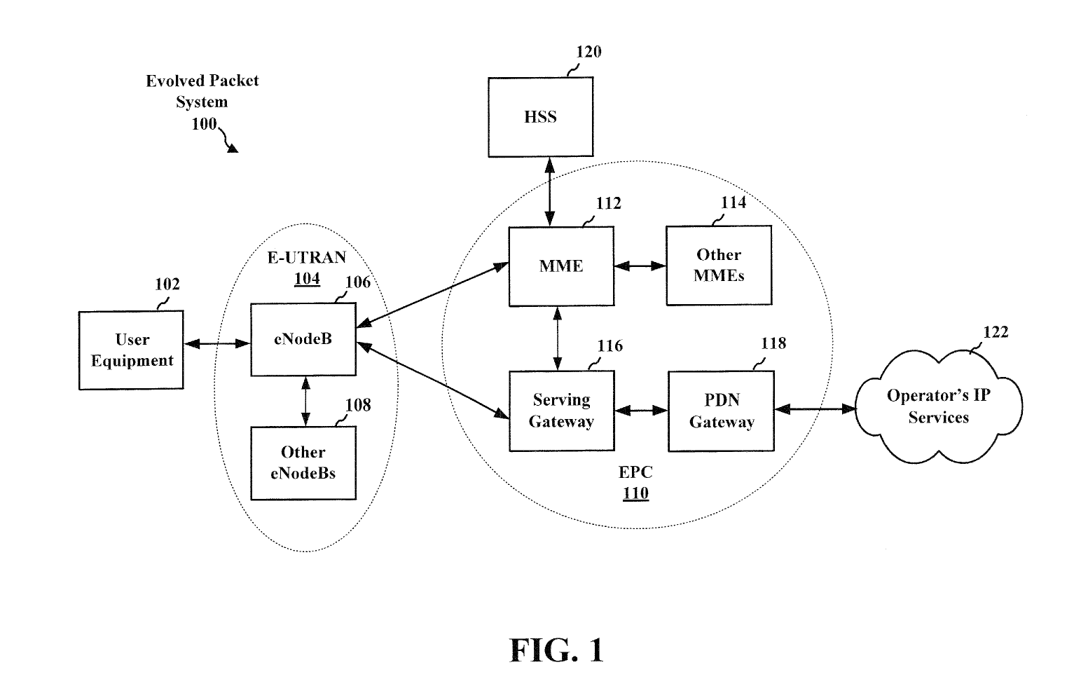

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the eNB 106 and other eNBs 108. The eNB 106 provides user and control planes protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

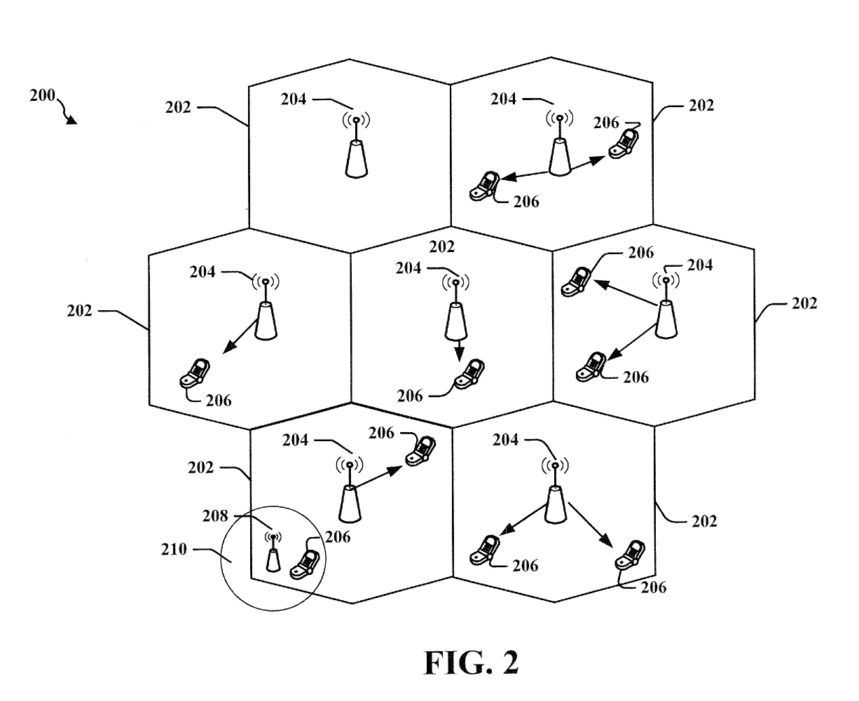

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at, the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

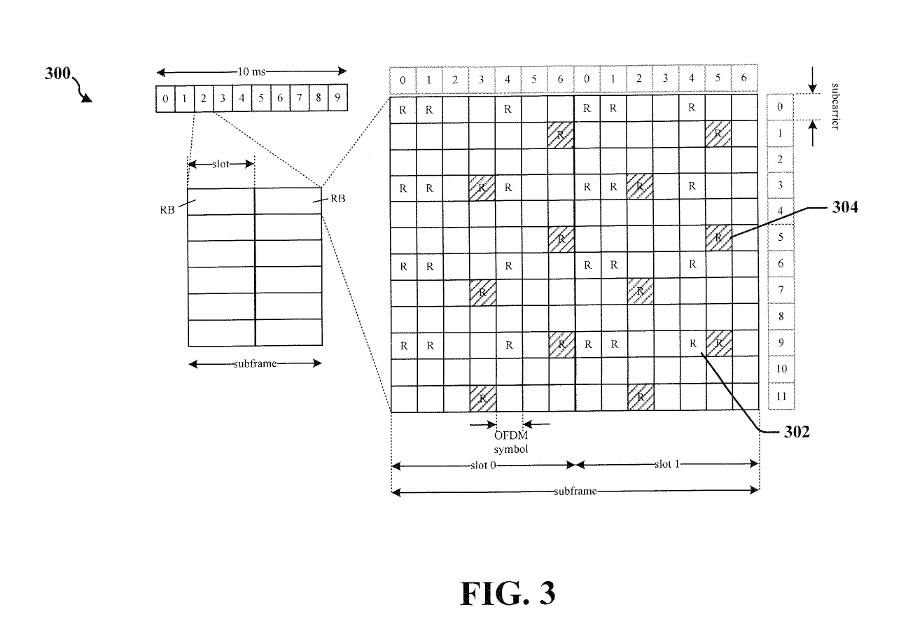

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

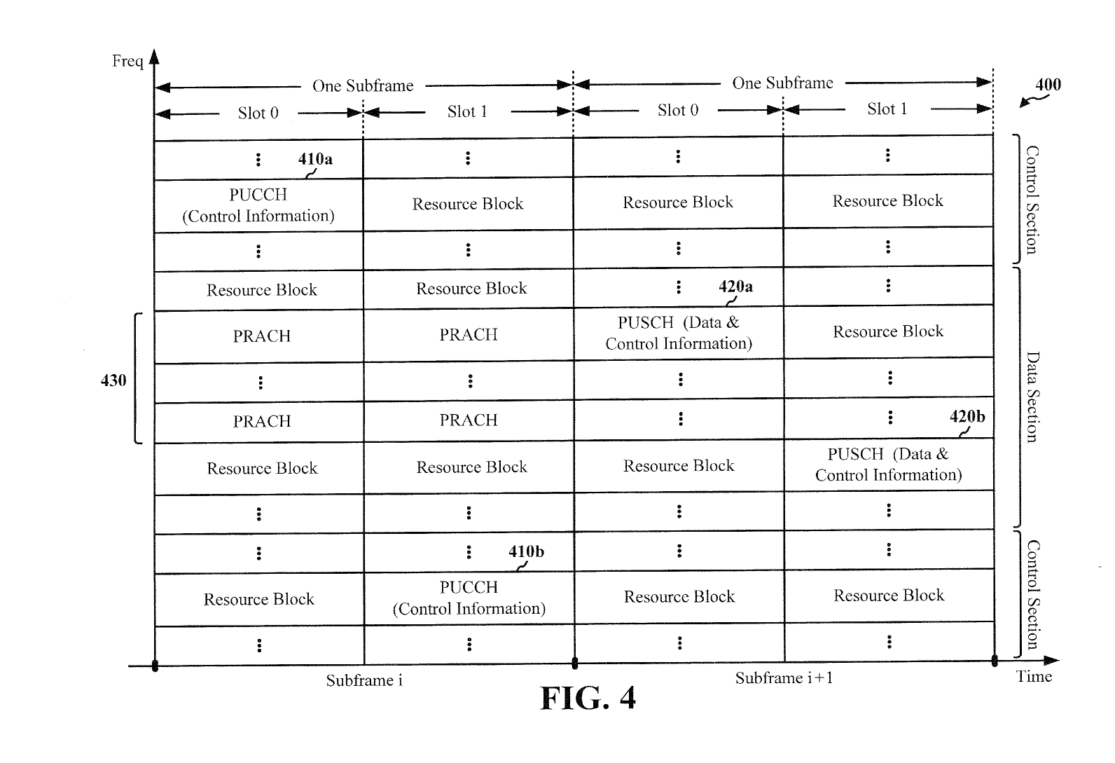

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

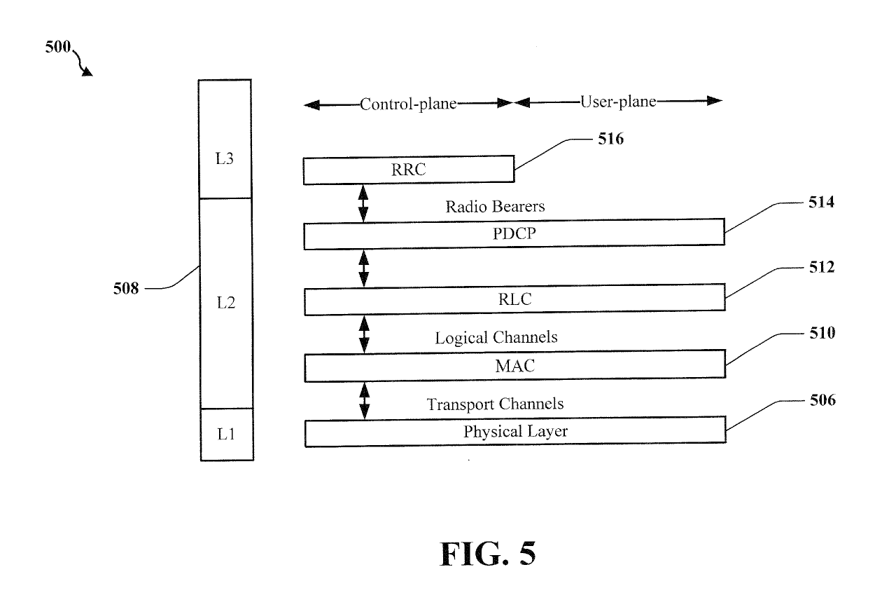

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

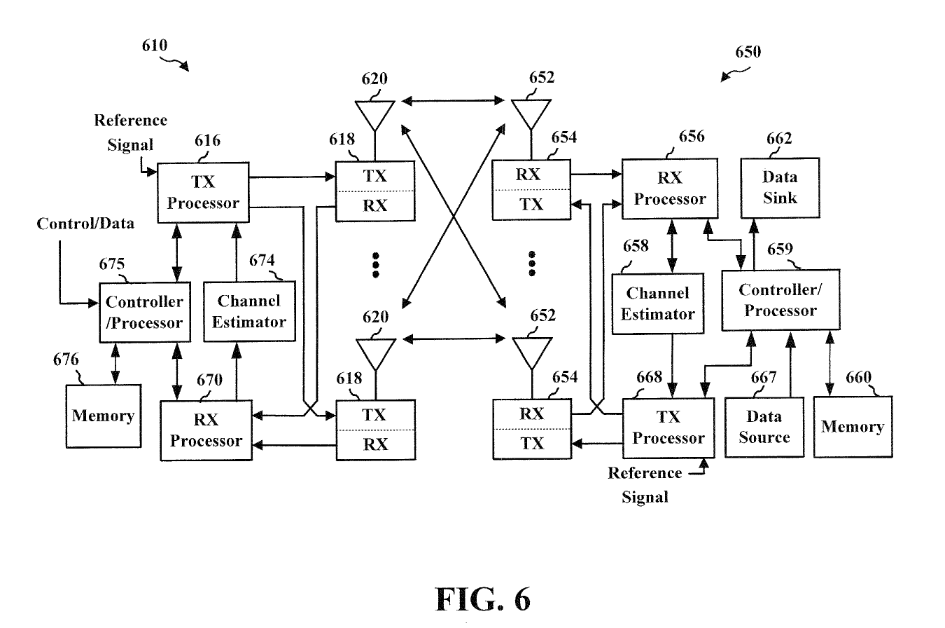

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

With traditional voice only cell phones, users are generally either on the phone talking or inactive. However, most modern smartphones receive periodic updates, such as email, throughout the day. Therefore, the actual talk time may only constitute a small fraction of the usage of the smartphone. In LTE, DRX is designed to optimize such applications. However, DRX configurations have large range and may be difficult to optimize. For example, the DRX-Inactivity Timer may range from 1.0 milliseconds (ms) to 2.56 s (e.g., T=PSF[1,2,3,4,5,6,8,10,20,30,40,50,60,80,100,200,300,500,750,1280,1920,2560]). On one hand, sending a UE to DRX quickly can save battery power by avoiding unnecessary monitoring of control channels. On the other hand, when data traffic arrives, there may be a delay in the transmission for the DL initiated traffic and possible random access channel (RACH) overhead for the UL initiated traffic. With a range from 1.0 ms to 2.56 s, it is entirely up to the eNB to decide what value to select for a UE.

Current LTE standards allow flexible configurations of DRX operations. Proper selection of the inactivity timer as well as the short and long DRX cycles can provide significant saving in UE power consumption. An eNB can either select a fixed configuration for DRX operation, which can be suboptimal for all users. Alternatively, an eNB may perform some training based on the traffic usage of a user, then adapt the DRX timer. However, this will incur delay. In addition, due to different user and application behaviors, it is unlikely that a fixed DRX configuration will work universally for all users.

During operation of a UE, approximately 50% of the UE's battery power may be consumed by the display, 20% may be consumed by the operating system (OS) of the UE, and 30% may be consumed by the modern of the UE operating in the active state. The modem may operate in one of four different states: (1) Active: RRC_Connected and Active time (2) DRX UL sync: RRC_Connected with finite and running timing advance timer (TAT) (3) DRX UL async: RRC_Connected with infinite TAT or expired TAT or (4) idle: RRC_Idle. The relative percentage of battery power consumed by each state of the modem is typically as follows: (1) Active: 100% (2) DRX UL sync: 15% (3) DRX UL async: 15% and (4) idle: 1%.

The operating states of a UE may be categorized as: (1) active (2) medium active and (3) dormant. During the active state, for example, the user may interact with the user interface (UI) of the UE or watch a video. For example, during the active state, a user may use the UE to perform activities such as Web browsing, checking emails, gaming, instant messaging (IM), or accessing YouTube™. Since the display of the UE is typically on during such activities, the display alone may consume 50% of the battery power. During the medium active state, the user may not be interacting with the UE (e.g., the UE is placed on a table) and applications running on the UE may be performing background tasks, such as periodic email polling or receiving emails pushed by a server according to a frequency configured by a user. Since the display of the UE is typically off during these activities, the medium active state consumes substantially less battery power than the active state. During the dormant state, the user is not interacting with the UI of the UE and the display of the UE typically remains off. Therefore, since the display is off during the medium active and dormant states, the battery power is consumed mainly by the OS and the modem. As such, the power saving benefits offered by DRX techniques may be more significant during the medium active and dormant states.

A user's usage pattern of a UE may vary at different times of the day. For example, during the day time, the user is likely to use the UE to perform activities such as Web browsing, checking email, gaming, IM, or accessing YouTube™. However, during the night (e.g., after the user goes to bed), applications may still be running in the background on the UE (e.g., periodic email polling, receiving emails pushed by a server, IM, or tasks involving the use of a global positioning system (GPS)). Therefore, assuming that a user sleeps for eight hours, then the UE may remain in the dormant state for eight hours and in the active or medium active states for 16 hours. Moreover, the UE may be in the active state for four hours and the medium active state for 12 hours. According to such usage patterns, the active state may consume approximately 30% of the battery power, the medium active state may consume approximately 25% to 50% of the battery power, and the dormant state may consume 2% to 20% of the battery power. Therefore, the active state may consume 30% of the total battery power, whereas the medium active and dormant states may consume up to 70% of the total battery power.

Assuming that the UE is stationary and operating in the dormant state, the UE needs to be able to place or receive calls. With respect to a regular voice only UE, the UE is in idle mode and wakes up only at paging slots (e.g., 2.56 s maximum). Such a configuration works well for a voice only type of UE. However, such a configuration does not work well for a smartphone type of UE due to substantially steady periodic background traffic. In other words, the specific background traffic and the purpose of the background traffic must be determined (e.g., whether network address translation (NAT) time-out is avoided or whether user datagram protocol (UDP) or transmission control protocol (TCP) is used). Typically, background bursts occur every 130 seconds on average or approximately every two minutes. In general, half of all the packets in such background bursts are less than 500 bytes.

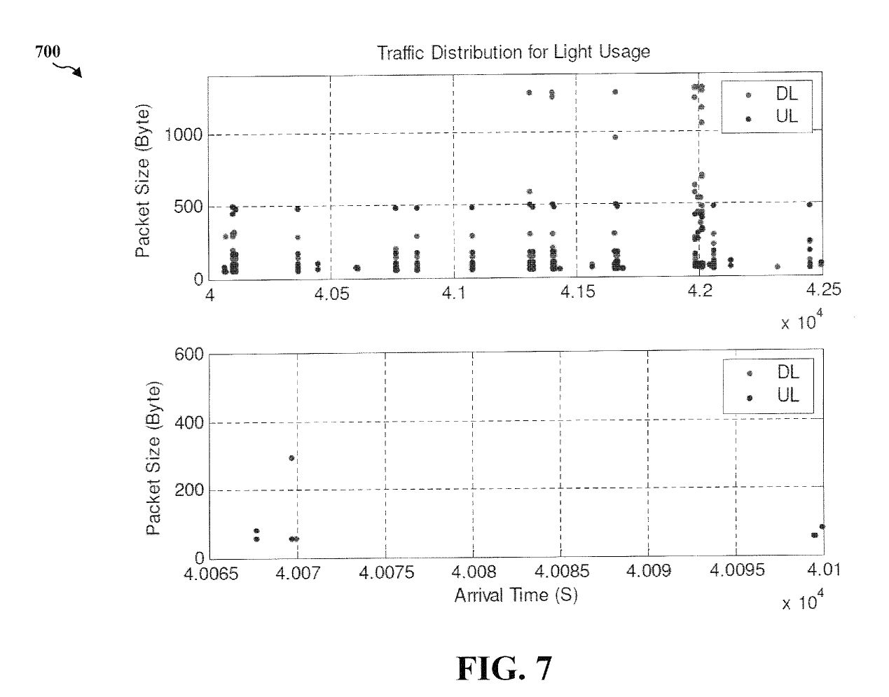

FIG. 7 is a diagram 700 illustrating a traffic distribution for a smartphone type of UE operating in a medium active state. As shown in FIG. 7, during a period of light usage (e.g., at 2 AM in the morning when a user is not interacting with the UE), DL and UL packets are frequently transmitted in bursts. For example, the DL packets may be keep-alive packets and the UL packets may be packets for polling a server for emails.

Since the idle state will create a call setup (e.g., non-access stratum (NAS) and RRC) every two minutes, the network will most likely place the UE in the DRX UL sync mode or DRX UL async mode. With respect to the DRX UL sync mode, although the UE may avoid a RACH procedure, the DRX UL sync mode may waste scheduling request (SR) resources and result in unnecessary channel quality indication (CQI) transmissions. With respect to the DRX UL async mode, although preserving SR resources and CQI transmissions, the UE may need to perform a RACH procedure approximately every two minutes.

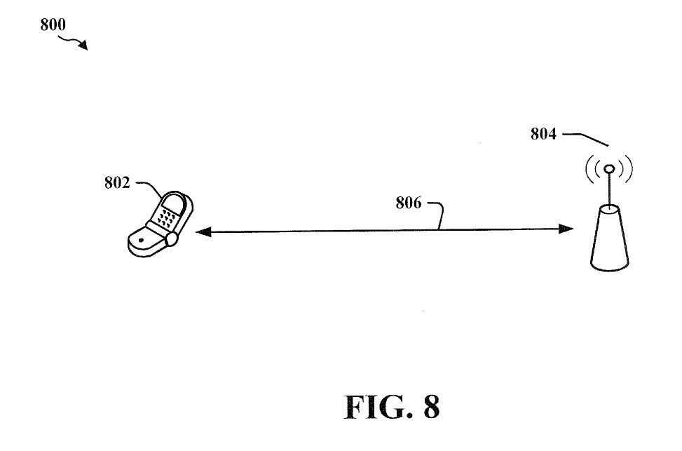

FIG. 8 is a diagram of an exemplary network 800 for implementing an exemplary method. As shown in FIG. 8, network 800 includes UE 802 and eNB 804, where the UE 802 may communicate with the eNB 804 via wireless connection 806. In one configuration, the UE 802 is configured to enter a gated mode of operation, where the gated mode includes a first time period followed by a second time period. The UE 802 may prevent application initiated data (e.g., data for polling an email server for emails) generated during the first time period from being transmitted over-the-air via the wireless connection 806 during the first time period. In other words, the UE 802 prevents autonomous data generated by an application running on the UE 802 from being transmitted during the first time period. For example, UL data may be barred per data radio bearer. The UE 802 may then permit over-the-air transmission via the wireless connection 806 during the second time period of the application initiated data generated during the first time period. The duration of the first and second time periods may be defined by a gating pattern, which may be pre-negotiated between the UE 802 and the eNB 804.

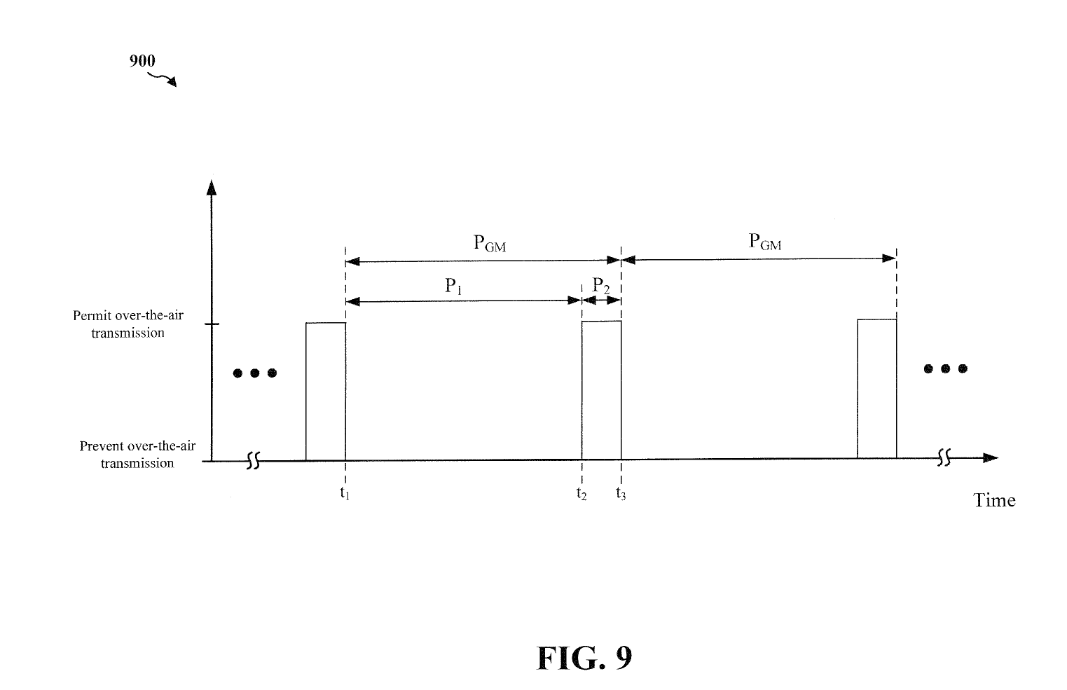

FIG. 9 is a diagram 900 illustrating an exemplary gating pattern that may be used by the UE 802 for the gated mode of operation. As shown in FIG. 9, the gating pattern may include repeating gated mode periods “P_{GM}”, where each P_{GM} includes a first period “P₁” and a second period “P₂”. As further shown in FIG. 9, an over-the-air transmission of application initiated data is prevented during P₁, whereas an over-the-air transmission of application initiated data generated during P₁ is permitted during P₂. In the configuration of FIG. 9, P₁ begins at a time “t₁” and ends at a time “t₂”, and P₂ begins at t₂, and ends at a time “t₃”. For example, each P_{GM} may be approximately 10.0 minutes in duration, where P₁ may be approximately 10.0 minutes less 50.0 ms in duration and P₂ may be approximately 50.0 ms in duration. In one configuration, the durations of P_{GM}, P₁, and/or P₂ may be configured by the eNB 804. Therefore, the background traffic load may be reduced from approximately every two minutes to approximately every 10.0 minutes.

For example, if an application (e.g., an email application) running on the UE 802 while in the gated mode attempts to transmit application initiated data (e.g., data for polling an email server for emails) during P₁, the UE 802 may prevent such transmission and may buffer the data. In one configuration, the data may be buffered in a memory device of the UE 802. Thereafter, the buffered data may be transmitted over-the-air during P7. However, if the application attempts to transmit data to the eNB 804 during P₂, the UE 802 may permit over-the-air transmission of such data.

The UE 802 operating in the gated mode may wake up at paging slots and may receive a page signal or other DL transmissions from the eNB 804 during P₁ and P₂. Accordingly, the UE 802 may support a voice call during P₁ and P₂ in response to a paging signal. In one configuration, the eNB 804 may allocate resources to the UE 802 during P₂. In such a configuration, the UE 802 may initiate an SR procedure with respect to the eNB 804 during P₂. However, if the SR procedure fails, the UE 802 may then immediately initiate a RACH procedure with respect to the eNB 804. Therefore, if the uplink of the UE 802 is time aligned with the eNB 804 during P₂, the RACH procedure may be avoided.

The UE 802 may be allowed to make calls (e.g., voice or data calls) that are initiated by the UE 802 when operating in the gated mode. More specifically, when the UE 802 initiates a call during P₁ or P₂, the gated mode may be temporarily suspended or terminated. In one configuration, the gated mode of operation may be suspended or terminated when a UI of the UE 802 detects user activity, such as a push of a physical button of the UE 802 by a user for making a call. Accordingly, upon detecting the user activity, the UE 802 may perform a RACH procedure to make a call or reinitiate the TAT.

In one configuration, the UE 802 operating in the gated mode may permit over-the-air transmission of delay sensitive data during P₁ and/or P₂. More specifically, when the UE 802 needs to transmit delay sensitive data during P₁ and/or P₂, the gated mode may be temporarily suspended or terminated. For example, the delay sensitive data may include data related to gaming applications and video streaming. In such a configuration, the application initiated data may include delay non-sensitive data such as data for polling an email server for emails.

In one configuration, the gated mode of operation may be requested by the UE 802 when needed via RRC/MAC signaling. In another configuration, the gated mode may be triggered in response to a user input. For example, when a user desires to conserve battery power, a user may push a button of the UE 802 to enter the gated mode and may maintain periodic connectivity to the eNB 804. Therefore, a user may control a tradeoff between battery power consumption and responsiveness of the UE 802. In another configuration, the UE 802 may enter the gated mode based on expiration of a timer. For example, the UE 802 may set a timer to 30.0 minutes and if a UI of the UE 802 does not detect any activity prior to expiration of the timer, the UE 802 may request to enter the gated mode. In another configuration, the UE 802 may enter the gated mode based on a programmed time, which may be set by a user. For example, the UE 802 may be set to enter the gated mode at 11:30 PM each night. In another configuration, the UE 802 may enter the gated mode based on a remaining battery power. For example, the UE 802 may enter the gated mode when the remaining battery power is less than a threshold, such as 20% of the total capacity of the battery.

The UE 802 may implement an application programming interface (API) that may be configured to send an indicator to an application running on the UE 802, where the indicator notifies the application that the UE 802 has entered or exited the gated mode. For example, with reference to FIG. 9, when an application running on the UE 802 attempts a UL transmission during P₁ of the gated mode, it may appear to the application that the UE 802 has lost its radio connection to the eNB 804 and proceed accordingly. Moreover, applications running on the UE 802 may be preconfigured to properly handle known and scheduled periods (e.g., P₁) during which the UE 802 prevents transmission of application initiated data.

The gated mode of operation of the UE 802 may provide several benefits. For example, the gated mode may retain total control over the air interface to limit or prevent transmission of application initiated data. As such, depending on the service carrier and data plan of the UE 802, the gated mode may reduce costs associated with over-the-air data transmissions. Since the gated mode may be entered in response to a user input as previously discussed, a user is granted control over the tradeoff between battery power consumption and responsiveness of the UE 802.

In addition, the gated mode may preserve network resources. For example, when UEs are operating in the gated mode, the traffic load (both RRC and NAS) experienced by a network may be reduced. RACH processing may also be reduced. Furthermore, since the eNB 804 has knowledge of the gating cycle implemented by the UE 802, the eNB 804 may be able to achieve more efficient resource multiplexing (e.g., SR, CQI) across many users. Furthermore, with reference to FIG. 9, the gated mode may enable bundling of keep-alive and polling messages generated by an application of the UE 802 during P₁, such that the bundled messages may be sent out in a single burst during P₂.

Therefore, the gated mode described herein may minimize battery power consumption of LTE smartphones without degrading user experience. Moreover, the gated mode may minimize over-the-air and backhaul signaling, as well as the consumption of resources.

Alternatively, in one aspect, the UE 802 may be configured to implement a DRX cycle having an extended period. For example, the DRX cycle may have a period longer than 2.56 s. In another aspect, the gated mode may be applied to only the traffic channel or control channels, such as PUCCH, SR, and RACH.

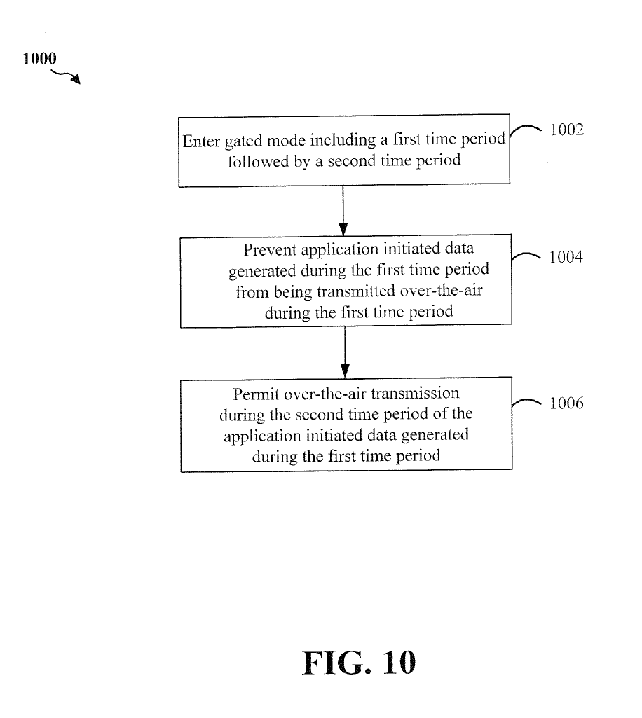

FIG. 10 is a flow chart 1000 of a method of wireless communication. The method may be performed by a UE. At step 1002, the UE may enter a gated mode including a first time period followed by a second time period. In one configuration, with reference to FIG. 9, the gated mode may include a first time period P₁ and a second time period P₂. For example, P₁ may be approximately 10.0 minutes less 50.0 ms in duration and P7 may be 50.0 ms in duration. In one configuration, the gated mode may be entered in response to an input, an expiration of a timer, a programmed time, and/or a remaining battery power.

At step 1004, the UE may prevent application initiated data generated during the first time period from being transmitted over-the-air during the first time period. For example, the application initiated data may be data generated by an email application running on the UE for polling an email server for new emails. For example, with reference to FIG. 9, the UE may prevent application initiated data generated during P₁ from being transmitted over-the-air to an eNB during P₁.

Finally, at step 1006, the UE may permit over-the-air transmission during the second time period of the application initiated data generated during the first time period. For example, with reference to FIG. 9, over-the-air transmission of application initiated data generated during P₁ may be permitted during P₂.

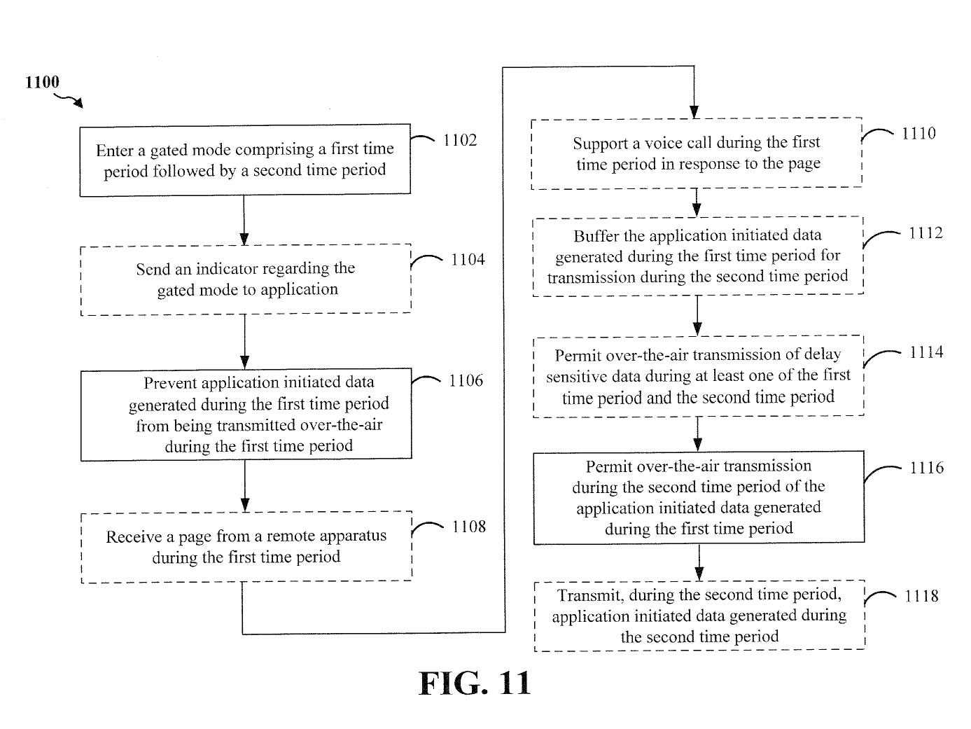

FIG. 11 is a flow chart 1100 of a method of wireless communication. The method may be performed by a UE. At step 1102, the UE may enter a gated mode including a first time period followed by a second time period. In one configuration, with reference to FIG. 9, the gated mode may include a first time period P₁ and a second time period P₂. For example, P₁ may be approximately 10.0 minutes less 50.0 ms in duration and P₂ may be 50.0 ms in duration. The gated mode may be entered in response to an input, an expiration of a timer, a programmed time, and/or a remaining battery power.

At step 1104, the UE may send an indicator regarding the gated mode to an application. In one configuration, the UE may implement an API that may be configured to send an indicator to an application running on the UE, where the indicator notifies the application that the UE has entered or exited the gated mode.

At step 1106, the UE may prevent application initiated data generated during the first time period from being transmitted over-the-air during the first time period. For example, the application initiated data may be data generated by an email application running on the UE for polling an email server for new emails. For example, with reference to FIG. 9, the UE may prevent application initiated data generated during P₁ from being transmitted over-the-air to an eNB during P₁.

At step 1108, the UE may receive a page from a remote apparatus during the first time period. For example, the UE operating in the gated mode may wake up at paging slots and may receive a page or other DL transmissions from an eNB during P₁ and P₂. At step 1110, the UE may support a voice call during the first time period in response to the page.

At step 1112, the UE may buffer the application initiated data generated during the first time period for transmission during the second time period. In one configuration, the data may be buffered in a memory device of the UE. For example, with reference to FIG. 9, if an email application running on the UE while in the gated mode attempts to transmit application initiated data (e.g., data for polling an email server for entails) during P₁, the UE may buffer the application initiated data. Thereafter, the buffered data may be transmitted over-the-air during P₂.

At step 1114, the UE 802 may permit over-the-air transmission of delay sensitive data during at least one of the first time period and the second time period. For example, the delay sensitive data may include data related to gaming applications and video streaming.

At step 1116, the UE may permit over-the-air transmission during the second time period of the application initiated data generated during the first time period. For example, with reference to FIG. 9, over-the-air transmission of application initiated data generated during P₁ may be permitted during P₂.

Finally, at step 1118, the UE may transmit over-the-air, during the second time period, application initiated data generated during the second time period. For example, with reference to FIG. 9, the UE may transmit over-the-air, during P₂, application initiated data generated during P₂.

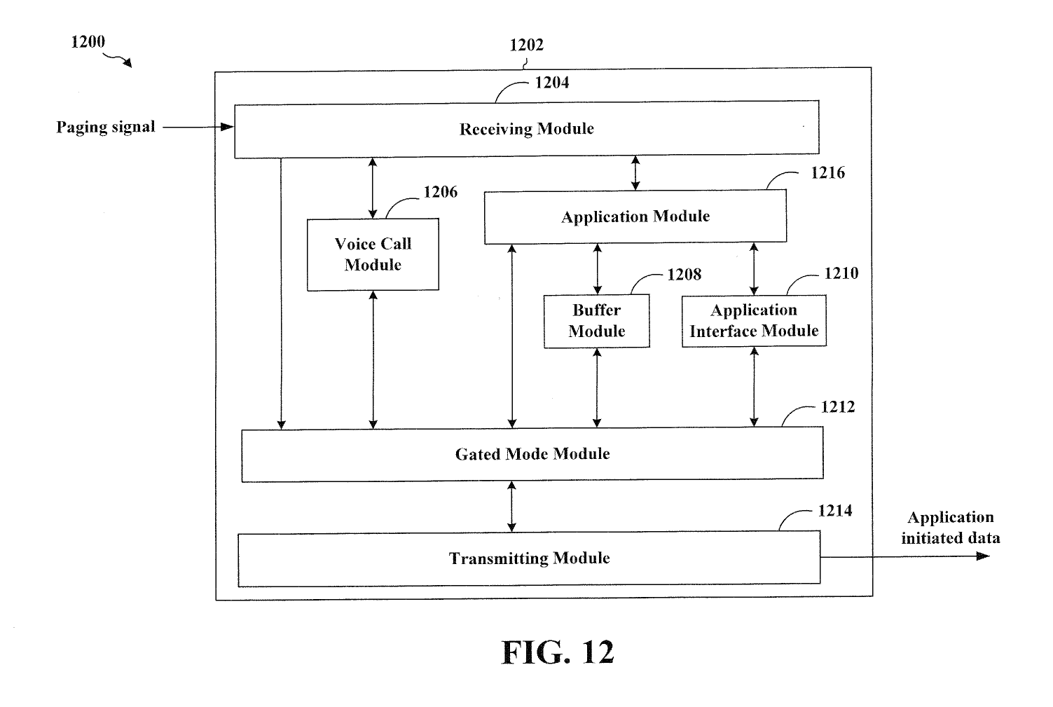

FIG. 12 is a conceptual data flow diagram 1200 illustrating the data flow between different modules/means/components in an exemplary apparatus 1202. The apparatus 1202 may be a UE. The apparatus 1202 includes a receiving module 1204 that may be configured to receive a page or other DL transmissions from a remote apparatus that is in communication with the apparatus 1202, a gated mode module 1212 that may be configured to enter a gated mode that includes a first time period and a second time period. The gated mode module 1212 may be further configured to prevent application initiated data generated during the first time period from being transmitted over-the-air during the first time period, and to permit over-the-air transmission during the second time period of the application initiated data generated during the first time period. In one configuration, the gated mode module 1212 may be further configured to permit over-the-air transmission of delay sensitive data during at least one of the first time period and the second time period. For example, the delay sensitive data may include data related to gaming applications and video streaming. In one configuration, the gated mode module 1212 may be configured by the remote apparatus. In another configuration, the gated mode module 1212 may be configured to enter the gated mode in response to an input, an expiration of a timer, a programmed time, and/or a remaining battery power.

The apparatus 1202 further includes a voice call module 1206 that may be configured to support a voice call during the first time period in response to a page, a buffer module 1208 that may be configured to buffer application initiated data generated during the first time period for transmission during the second time period, an application interface module 1210 that may be configured to send an indicator regarding the gated mode to an application of the UE. The apparatus 1202 further includes a transmitting module 1214 that may be configured to transmit, during the second time period, application initiated data generated during the second time period. The apparatus 1202 further includes an application module 1216 that may include one or more applications (e.g., an email application) configured to generate data for transmission.

The apparatus may include additional modules that perform each of the steps of the algorithm in the aforementioned flow chart FIGS. 9 and 10. As such, each step in the aforementioned flow chart FIGS. 9 and 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

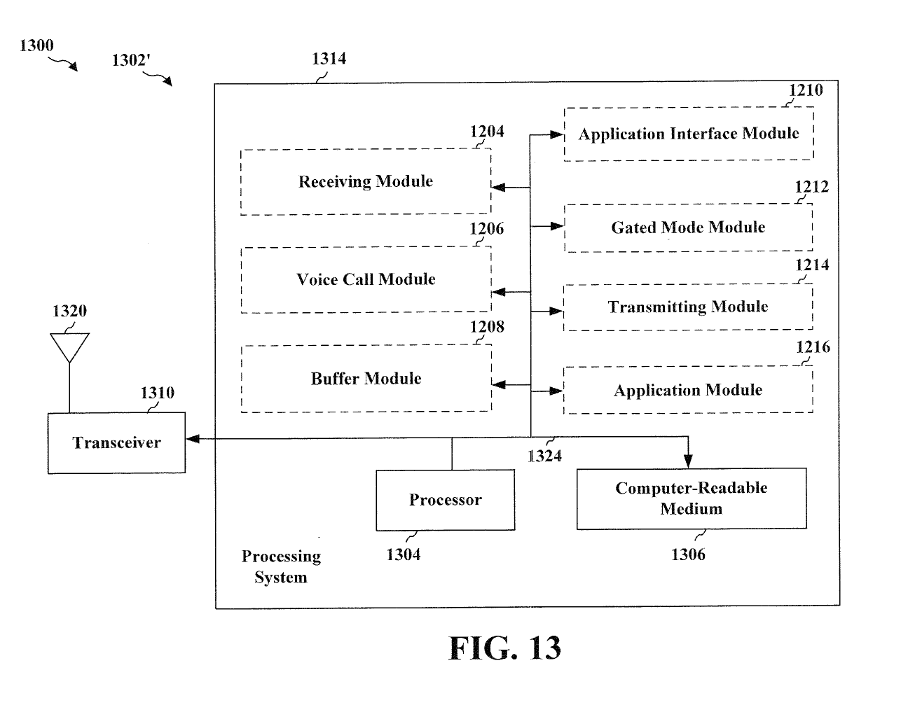

FIG. 13 is a diagram illustrating an example of a hardware implementation for an apparatus 102′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212, 1214, 1216, and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, 1212, 1214 and 1216. The modules may be software modules running in the processor 1304, resident/stored in the computer readable medium 1306, one or more hardware modules coupled to the processor 1304, or some combination thereof. The processing system 1314 may be a component of the UE 650 and may include the memory 660 and/or at least one of the TX processor 668, the RX processor 656, and the controller/processor 659.

In one configuration, the apparatus 102/102′ for wireless communication includes means for entering a gated mode including a first time period followed by a second time period, means for preventing application initiated data generated during the first time period from being transmitted over-the-air during the first time period, and means for permitting over-the-air transmission during the second time period of the application initiated data generated during the first time period. The apparatus 102/102′ for wireless communication further includes means for receiving a page from a remote apparatus during the first time period, means for supporting a voice call during the first time period in response to the page, means for buffering the application initiated data generated during the first time period for transmission during the second time period, means for transmitting, during the second time period, application initiated data generated during the second time period, and means for sending an indicator regarding the gated mode to an application.

The aforementioned means may be one or more of the aforementioned modules of the apparatus 102 and/or the processing system 1314 of the apparatus 102′ configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to he dedicated to the public regardless of whether such disclosure is explicitly recited in the claims. No claim element is to be construed as a means plus function unless the element is expressly recited using the phrase “means for.”

What is claimed is:

1. A method of communication from an apparatus, comprising:
entering a gated mode comprising a first time period followed by a second time period;
preventing application initiated data generated during the first time period from being transmitted over-the-air during the first time period; and
permitting over-the-air transmission during the second time period of the application initiated data generated during the first time period.

2. The method of claim 1, wherein the gated mode is configured by a remote apparatus that is in communication with the apparatus.

3. The method of claim 1, further comprising receiving a page from a remote apparatus during the first time period.

4. The method of claim 3, further comprising supporting a voice call during the first time period in response to the page.

5. The method of claim 1, further comprising buffering the application initiated data generated during the first time period for transmission during the second time period.

6. The method of claim 1, further comprising transmitting, during the second time period, application initiated data generated during the second time period.

7. The method of claim 1, wherein entering the gated mode comprises entering the gated mode based on at least one of an input, an expiration of a timer, a programmed time, and a remaining battery power.

8. The method of claim 1, further comprising sending an indicator regarding the gated mode to an application.

9. The method of claim 1, further comprising:
permitting over-the-air transmission of delay sensitive data during at least one of the first time period and the second time period,
wherein the application initiated data is delay non-sensitive data.

10. An apparatus for wireless communication, comprising:
means for entering a gated mode comprising a first time period followed by a second time period;
means for preventing application initiated data generated during the first time period from being transmitted over-the-air during the first time period; and
means for permitting over-the-air transmission during the second time period of the application initiated data generated during the first time period.

11. The apparatus of claim 10, wherein the gated mode is configured by a remote apparatus that is in communication with the apparatus.

12. The apparatus of claim 10, further comprising means for receiving a page from a remote apparatus during the first time period.

13. The apparatus of claim 12, further comprising means for supporting a voice call during the first time period in response to the page.

14. The apparatus of claim 10, further comprising means for buffering the application initiated data generated during the first time period for transmission during the second time period.

15. The apparatus of claim 10, further comprising means for transmitting, during the second time period, application initiated data generated during the second time period.

16. The apparatus of claim 10, wherein the means for entering the gated mode is configured to enter the gated mode based on at least one of an input, an expiration of a timer, a programmed time, or a remaining battery power.

17. The apparatus of claim 10, further comprising means for sending an indicator regarding the gated mode to an application.

18. The apparatus of claim 10, further comprising:
means for permitting over-the-air transmission of delay sensitive data during at least one of the first time period and the second time period,
wherein the application initiated data is delay non-sensitive data.

19. A computer program product, comprising:
a computer-readable medium comprising code for:
entering a gated mode comprising a first time period followed by a second time period;
preventing application initiated data generated during the first time period from being transmitted over-the-air during the first time period; and
permitting over-the-air transmission during the second time period of the application initiated data generated during the first time period.

20. The computer program product of claim 19, wherein the gated mode is configured by a remote apparatus that is in communication with the apparatus.

21. The computer program product of claim 19, wherein the computer-readable medium further comprises code for receiving a page from a remote apparatus during the first time period.

22. The computer program product of claim 21, wherein the computer-readable medium further comprises code for supporting a voice call during the first time period in response to the page.

23. The computer program product of claim 19, wherein the computer-readable medium further comprises code for buffering the application initiated data generated during the first time period for transmission during the second time period.

24. The computer program product of claim 19, wherein the computer-readable medium further comprises code for transmitting, during the second time period, application initiated data generated during the second time period.

25. The computer program product of claim 19, wherein the computer-readable medium further comprises code for entering the gated mode based on at least one of an input, an expiration of a timer, a programmed time, and a remaining battery power.

26. The computer program product of claim 19, wherein the computer-readable medium further comprises code for sending an indicator regarding the gated mode to an application.

27. The computer program product of claim 19, wherein the computer-readable medium further comprises code for permitting over-the-air transmission of delay sensitive data during at least one of the first time period and the second time period,
wherein the application initiated data is delay non-sensitive data.

28. An apparatus for wireless communication, comprising:
a processing system configured to:
enter a gated mode comprising a first time period followed by a second time period;
prevent application initiated data generated during the first time period from being transmitted over-the-air during the first time period; and
permit over-the-air transmission during the second time period of the application initiated data generated during the first time period.

29. The apparatus of claim 28, wherein the gated mode is configured by a remote apparatus that is in communication with the apparatus.

30. The apparatus of claim 28, wherein the processing system is further configured to receive a page from a remote apparatus during the first time period.

31. The apparatus of claim 30, wherein the processing system is further configured to support a voice call during the first time period in response to the page.

32. The apparatus of claim 28, wherein the processing system is further configured to buffer the application initiated data generated during the first time period for transmission during the second time period.

33. The apparatus of claim 28, wherein the processing system is further configured to transmit, during the second time period, application initiated data generated during the second time period.

34. The apparatus of claim 28, wherein the processing system is further configured to enter the gated mode based on at least one of an input, an expiration of a timer, a programmed time, and a remaining battery power.

35. The apparatus of claim 28, wherein the processing system is further configured to send an indicator regarding the gated mode to an application.

36. The apparatus of claim 28, wherein the processing system is further configured to permit over-the-air transmission of delay sensitive data during at least one of the first time period and the second time period,
wherein the application initiated data is delay non-sensitive data.
